(19) United States
(12) Patent Application Publication
(10) Pub. No.: US 2023/0374337 A1
(43) Pub. Date: Nov. 23, 2023

(54) HIGH PERFORMANCE CONFORMAL COATINGS

(71) Applicant: Epoxy Technology, Inc., Billerica, MA (US)

(72) Inventors: Robert K. Ddamulira, Chattanooga, TN (US); Jeffrey A. Sargeant, Cranston, RI (US); Ziyi Hu, Acton, MA (US); Sizhong Dong, North Chelmsford, MA (US)

(73) Assignee: Epoxy Technology, Inc., Billerica, MA (US)

(21) Appl. No.: 18/321,402

(22) Filed: May 22, 2023

Related U.S. Application Data
(60) Provisional application No. 63/365,056, filed on May 20, 2022.

(51) Int. Cl. C09D 133/14; C09D 163/00

(52) U.S. Cl. CPC C09D 133/14; C09D 163/00

(57) ABSTRACT

Disclosed herein are various embodiments and examples of conformal coatings that are formed by a variety of formulations and curing methods. In one embodiment, resins that are capable of thiol-ene polymerization are used. In another embodiment, reactive acrylic liquid elastomers are used. In yet another embodiment, epoxy resins are used in combination with other chemistries to produce useful physical properties for the conformal coatings.

### CROSS-REFERENCE TO RELATED APPLICATIONS

This application claims priority to pending U.S. Provisional Patent Application No. 63/365,056, titled “High Performance Conformal Coatings,” filed on May 20, 2022, which is expressly incorporated by reference herein in its entirety.

### FIELD OF INVENTION

The present disclosure generally relates to conformal coatings and methods of forming such conformal coatings. More specifically, the present disclosure relates to conformal coatings for use as protective coatings for electronic components and assemblies and methods for forming such conformal coatings.

### BACKGROUND

Many modern and advanced industrial and consumer products and systems rely on small and delicate electrical assemblies such as printed circuit boards, printed wiring boards, and other such combinations of electrical circuitry. Such electrical assemblies typically include one or more insulating substrates sandwiched together into a thin assembly, with a series of conductive and selectively interconnected lines, such as traces, formed on a surfaces of the substrates. Traces can be formed by various processes such as chemical etching of a conductive layer applied to a surface of a substrate or direct printing of conductive material onto the substrate. Additional electrical components can be added to the substrates through soldering and other such processes.

Once assembled, such electrical assemblies are relatively fragile and delicate and subject to damage if not carefully handled or subject to failure or poor performance due to exposure to and interaction with moisture, particulates, and other environmental factors. One method of protecting such fragile and delicate electrical assemblies is to apply a thin polymer coating or film that conforms to the contours of the traces and other components and seals the traces and components to mitigate or eliminate damage and harmful interaction with environmental factors. Such coatings and films are commonly referred to as “conformal coatings.” Disclosed herein are several novel compositions and methods of forming such compositions useful as conformal coatings that provide certain advantages over prior art compositions.

### SUMMARY

Disclosed herein are various embodiments and examples of conformal coatings that are formed by a variety of formulations and curing methods. In one embodiment, resins that are capable of thiol-ene polymerization are used. In another embodiment, reactive acrylic liquid elastomers are used. In yet another embodiment, epoxy resins are used in combination with other chemistries to produce useful physical properties for the conformal coatings.

### DETAILED DESCRIPTION

The compositions and methods disclosed in this document are described in detail by way of examples. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of conformal coatings and methods for forming such coatings are hereinafter disclosed and described in detail.

The conformal coatings described herein are formed by combinations of resin chemistries and curing methods that result in coatings that are useful as, among other applications, protective coatings for electronic assemblies.

In one general embodiment, conformal coatings comprise a resin capable of thiol-ene polymerization, i.e., a reaction between a thiol and an alkene to form a thioether. Such an embodiment can be formed through multiple formulation options including one-part and two-part formulations. For example, a one-part coating composition can be formed using a thiol-ene polymerizable resin with sufficient initiators to allow polymerization by ultraviolet (UV) light or visible light. In another example, a one-part coating composition can be formed using a thiol-ene polymerizable resin in combination with sufficient initiators to allow curing by reaction with UV light or visible light and/or the presence of moisture. In another example, a one-part coating composition can be formed using a thiol-ene polymerizable resin in combination with sufficient initiators to allow curing by reaction with UV light and/or the application of heat.

In one embodiment, a thiolene resin includes appropriate crosslinking agents containing carbon-carbon double bonds, for example diallyl phthalate (DAP) or any of a variety of acrylic monomers for example 2-mole ethoxylated bisphenol A dimethacrylate (which is sold as Sartomer SR348). The addition of such crosslinking materials can increase electrical insulating properties, dimensional stability, and thermal resistance. In addition, such embodiments can incorporate the use of stabilizing compounds such as triphenyl phosphite, 4-methoxy-1-naphthol or similar materials. Such embodiments can be cured by exposure to a full spectrum mercury vapor UV lamp (UV-LED with a wavelength of 365 nm) for 30 to 120 seconds.

An example of a two-part composition uses a thiol-ene polymerizable resin in combination with an epoxy resin or a combination of epoxy resins or with sufficient initiators (for example, an epoxy-imidazole adduct curing agent) to allow curing by application of heat in five minutes or less. In another example a two-part composition uses a thiol-ene polymerizable resin in combination with an epoxy resin or a combination of epoxy resins or sufficient initiators (for example, a phosphonium ionic liquid catalyst) to allow curing by the application of heat to create a cured coating with a high glass transition temperature.

In another general embodiment, conformal coatings comprise a reactive acrylic liquid elastomer. The resulting conformal coating are highly flexible and provide electrical insulative properties. Such an embodiment can be formed through multiple formulary options. In a first example, a one-part coating composition comprises a reactive liquid acrylic liquid elastomer containing silyl functional groups and sufficient initiators to allow the elastomer to polymerize through condensation cure upon exposure to moisture at room temperature or elevated temperature. In another example, a one-part coating composition comprises a reactive liquid acrylic liquid elastomer containing acrylate functional groups and sufficient initiators to allow the elastomer to polymerize upon exposure to UV light or electron beam (“EB”) radiation, optionally in combination with applied heat. In another example, a one-part coating composition comprises a combination of reactive liquid acrylic liquid elastomers containing silyl and acrylate functional groups and sufficient initiators to allow the elastomer to polymerize upon exposure to UV light or EB radiation, moisture or heat. In another example, a one-part coating composition comprises a reactive liquid acrylic liquid elastomer, containing silyl functional groups, in combination with an epoxy resin or blend of epoxy resins and sufficient initiators to allow the elastomer to polymerize through condensation cure upon exposure to moisture at room temperature or elevated temperature. In another example, a one-part coating composition comprises a reactive liquid acrylic liquid elastomer containing acrylate functional groups in combination with an epoxy resin or blend of epoxy resins and sufficient initiators to allow the elastomer to polymerize upon exposure to UV or EB radiation, optionally in combination of applied heat. In another example, a one-part coating composition comprises a combination of reactive liquid acrylic liquid elastomers containing silyl and acrylate functional groups in combination with an epoxy resin or blend of epoxy resins and sufficient initiators to allow the elastomer to polymerize upon exposure to UV or EB radiation, moisture or heat.

In another general embodiment, conformal coatings are formed using epoxy resin chemistries that result in a coating with useful physical properties such as chemical resistance, adhesion, abrasion resistance, temperature and humidity resistance, and electrical properties. Such an embodiment can be formed through multiple formulary options.

In one example of forming conformal coatings with useful physical properties, the conformal coating uses a two-part epoxy system in combination with a volatile diluent at between a one percent and 10 percent concentration. The first two components can be mixed prior to application onto the electrical assemblies that are to be protected, and the volatile diluent can be added to adjust coating viscosity before or during application of the conformal coating to the electrical assembly. Such a conformal coating can comprise a first part comprising an epoxy resin or combination of epoxy resins, along with reactive and/or volatile diluent and a second part comprising a single or combination of imidazole(s), along with reactive and/or volatile diluents. Alternatively, such a conformal coating can comprise a first part of an epoxy resin or combination of epoxy resins, along with reactive and/or volatile diluent and a second part comprising a single or combination of amine(s), polyamines, along with reactive and/or volatile diluents. Alternatively, the conformal coating can comprise a first part comprising an epoxy resin or combination of epoxy resins, along with reactive and/or volatile diluent and a second part comprising a single or combination of mercaptan curing agents, along with reactive and/or volatile diluents. In yet another alternative, the conformal coating can comprise a first part comprising an epoxy resin or combination of epoxy resins, along with reactive and/or volatile diluent and a second part comprising a single or combination anhydrides, along with reactive and/or volatile diluents.

In one embodiment of a two-part epoxy system, the diluent used can be an organic solvent such as methyl ethyl ketone (MEK), at 10-15 percent, or other suitable solvents such as acetone. The epoxy resin used can be bisphenol A-co-epichlorohydrin and an imidazole curing agent used can be used such as 1-cyanoethyl-2-ethyl-4-methylimidazole. In another embodiment, a bisphenol A epoxy resin is combined with a polymeric epoxy such as Olin 684-EK40 (a combination of MEK and phenol, 4,4′-(1-methylethylidene)bis-, polymer with 2,2′-[(1-methylethylidene)bis(4,1-phenyleneoxymethylene)]bis [oxirane], with the MEK at a concentration of 50-70%). Such a combination provides good film forming properties, flexibility and impact resistance.

In another example of forming conformal coatings with useful physical properties, the conformal coating is formulated using a solution of a thermoplastic epoxy resin in a volatile organic solvent/diluent. Such combination creates a coating of suitable viscosity for easy application via dipping, brushing, or spraying methods. The formulation, once deposited on a substrate, can be dried at room temperature or elevated temperature to remove the carrier solvent leaving behind a cohesive, flexible, clear epoxy film. The coating can later be removed by dissolving in organic solvent, allowing access to the protected device for inspection or repair. Such a conformal coating can combine a thermoplastic linear epoxy polymer, such as an Olin 684-based epoxy resin, with methyl ethyl ketone. Alternatively, such a conformal coating can combine a thermoplastic linear epoxy polymer (as described above) with methyl ethyl ketone and an amount of isocyanate resin to allow further crosslinking by application of heat. This alternative can increase the adhesion and barrier properties of the epoxy film, which is useful for demanding environments. Alternatively, such a conformal coating can combine a thermoplastic linear epoxy polymer (as described above) with methyl ethyl ketone and a cationic UV light cure catalyst to allow further reaction of the applied coating through exposure to UV light. This approach can increase the adhesion and barrier properties of the epoxy film.

A polymeric epoxy in organic solvent, such as Olin 684-EK40, forms a final coating film that can be easily reworked or removed. In one embodiment of a polymeric epoxy solution Olin 684-EK40 is combined with 3% of a cycloaliphatic epoxide resin, such as ERL-4221 (3,4-epoxycyclohexanemethyl 3,4-epoxycyclohexanecarboxylate), combined with a heat cure catalyst such as K-Pure CXC-1612 Blocked Acid Catalyst (available from King Industries) at between 0.01-1.0 wt. %. Such a combination yields higher glass transition temperature (T_{g}).

In another example of forming conformal coatings with useful physical properties, the conformal coatings is a one-part 100% solids epoxy conformal coating comprising 100% solids epoxy resin (or combination of epoxy resins), a reactive diluent, and a curing agent of sufficient latency to provide a stable formulation that does not react until subjected to proper elevated temperature. When expose to this temperature, the composition cures with significant and useful mechanical, adhesive, and electrical properties.

In another example for forming conformal coatings with useful physical properties, the conformal coating is formulated using a solution of a thermoplastic phenoxy (aka polyhydroxy ether) resin in a volatile organic solvent/diluent. A high molecular weight polyhydroxyl ether (such as Gabriel PKHH) is one example of such a phenoxy resin among others. Such combination creates a coating of suitable viscosity for application via dipping, brushing, or spraying methods. The formulation, once deposited on a substrate, can be dried at room temperature or elevated temperature to remove the carrier solvent leaving behind a cohesive, flexible, clear epoxy film. Such a combination results in good electrical, mechanical and environmental properties.

In one embodiment, a phenoxy resin is used in combination with a Bisphenol F type epoxy (for example Araldite GY282), a UV curable epoxy polymer (for example ERL 4221), a flexiblizing resin (for example, Poly BD650E), and a cationic photoinitiator) for example, UVI 6976). Such combination yields good electrical, mechanical and environmental properties. In other embodiments, UV cationic curing agents can be replaced with a heat cure catalyst such as K-Pure CXC-1612. The above embodiments could also be used in combination with latent curing agents. The above embodiments could also be used in combination with a blocked acid type thermal initiator at 0.01-1.0 weight percent.

In another embodiment of forming conformal coatings with useful physical properties, the conformal coating is a one-part 100% solids epoxy conformal coating containing a 100% solids epoxy resin (or a combination of epoxy resins), a reactive diluent, and a UV curing agent of sufficient latency to provide a stable formulation that does not react until exposed to UV light. An example of such a coating composition is a mixture of a cycloaliphatic epoxy resin, such as 3,4-epoxycyclohexylmethyl-3,4-epoxycyclohexanecarboxylate (for example Syna 21) at a 30-50 weight percent, one or more cationic photoinitiator(s) at 0.1-2.0 weight percent, and a cyclic ether cationic monomer at 40-50 weight percent.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A conformal coating comprising:
resin capable of thiol-ene polymerization; and
an initiator.

2. The conformal coating of claim 1, wherein the initiator allows for polymerization by ultraviolet light.

3. The conformal coating of claim 1, further comprising a crosslinking agent that contains a carbon-carbon double bond.

4. The conformal coating of claim 3, wherein the crosslinking agent is diallyl phthalate.

5. The conformal coating of claim 3, wherein the crosslinking agent is ethoxylated bisphenol A dimethacrylate.

6. The conformal coating of claim 1, further comprising a stabilizing compound.

7. The conformal coating of claim 6, wherein the stabilizing compound is triphenyl phosphite, 4-methoxy-1-naphthol.

8. A conformal coating comprising:
a reactive acrylic liquid elastomer; and
an initiator.

9. The conformal coating of claim 8, wherein the initiator allows for polymerization by ultraviolet light.

10. The conformal coating of claim 8, wherein the reactive acrylic liquid elastomer includes an acrylate functional groups.

11. The conformal coating of claim 8, wherein the reactive acrylic liquid elastomer includes silyl and acrylate functional groups.

12. A conformal coating comprising:
a two-part epoxy system; and
a volatile dilutant.

13. The conformal coating of claim 12, wherein the volatile dilutant is added in between one percent and 10 percent as compared to the two-part epoxy system.

14. The conformal coating of claim 12, wherein a first part of the epoxy system comprises an epoxy resin and a second part of the epoxy system comprises an imidazole.

15. The conformal coating of claim 12, wherein a first part of the epoxy system comprises an epoxy resin and a second part of the epoxy system comprises an amine.

16. The conformal coating of claim 12, wherein a first part of the epoxy system comprises an epoxy resin and a second part of the epoxy system comprises a polyamines.

17. The conformal coating of claim 12, wherein a first part of the epoxy system comprises an epoxy resin and a second part of the epoxy system comprises an anhydrides.

18. A conformal coating comprising:
a thermoplastic epoxy resin; and
a volatile organic solvent.

19. The conformal coating of claim 18, wherein the thermoplastic epoxy resin is a thermoplastic linear epoxy polymer.

20. The conformal coating of claim 18, wherein the volatile organic solvent is methyl ethyl ketone.
